(19) United States
(12) Patent Application Publication
(10) Pub. No.: US 2017/0166459 A1
(43) Pub. Date: Jun. 15, 2017

(54) EXTERNALLY ENHANCED ELECTROCOAGULATION

(71) Applicant: William Jansen, Bloomington, MN (US)

(72) Inventor: William Jansen, Bloomington, MN (US)

(21) Appl. No.: 15/375,454

(22) Filed: Dec. 12, 2016

Related U.S. Application Data
(60) Provisional application No. 62/267,082, filed on Dec. 14, 2015.

(51) Int. Cl. C02F 1/463; C02F 1/461

(52) U.S. Cl. CPC C02F 1/463; C02F 1/46104; C02F 2201/46105; C02F 2101/20

(57) ABSTRACT

A water treatment system including a reaction chamber having an anode and a cathode is presented. The reaction chamber is configured to conduct an electrocoagulation reaction between the anode and the cathode. The water treatment system also includes an external ion generator, separate from the anode, configured to provide free metal ions to the water treatment system.

### CROSS-REFERENCE TO RELATED APPLICATION

The present application is based on and claims the benefit of U.S. Provisional Patent Application Ser. No. 62/267,082 filed Dec. 14, 2015, the content of which is hereby incorporated by reference in its entirety.

### BACKGROUND

Electrocoagulation is an economical water treatment technology. Electrocoagulation comprises, for example, applying an electrical charge to water such that particle surface charges change. Electrocoagulation facilitates the suspension of particulates, forming a more-easily removed agglomeration. In addition, electrocoagulation can reduce the amount of necessary filters, additives, and other chemicals needed to remove suspended solids, oil, grease and heavy metals from a water treatment stream.

The discussion above is merely provided for general background information and is not intended to be used as an aid in determining the scope of the claimed subject matter.

### SUMMARY

A water treatment system including a reaction chamber having an anode and a cathode is presented. The reaction chamber is configured to conduct an electrocoagulation reaction between the anode and the cathode. The water treatment system also includes an external ion generator, separate from the anode, configured to provide free metal ions to the water treatment system.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a prior art waste treatment reaction cell.

FIG. 2 illustrates a water treatment system in accordance with one embodiment of the present invention.

FIG. 3 illustrates a water treatment system in accordance with one embodiment of the present invention.

FIG. 4 illustrates a water treatment system with multiple chambers in accordance with an embodiment of the present invention.

FIG. 5 illustrates a water treatment system with a recycle loop in accordance with an embodiment of the present invention.

FIG. 6 illustrates a method of treating waste water in accordance with one embodiment of the present invention.

While embodiments of the present invention are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention

### DETAILED DESCRIPTION OF ILLUSTRATIVE EMBODIMENTS

Electrocoagulation and electroflotation are rapidly growing areas of waste water treatment due to their ability to remove contaminants that are generally more difficult to remove by filtration or chemical treatment systems, such as emulsified oil, total petroleum hydrocarbons, refractory organics, suspended solids, and/or heavy metals. In one embodiment, electrocoagulation is accomplished by a reaction chamber, within an electrocoagulation system, that provides a charge to a water-based solution having contaminants. In one embodiment, this involves applying a voltage across a pair of electrodes to produce metal ions that, in solution, allow the contaminants to form as a mass, which can be removable from the solution through filtration. In one embodiment, this mass of contaminants, or floc, is removable from the reaction chamber as floating waste or sediment waste based on the density of the mass.

In a water based environment, heavy metals and waste products, organic and inorganic, are primarily held in solution by electrical charges. In one embodiment, the production of metal ions through electrocoagulation allows for a destabilization of those electrical charges keeping the heavy metals and waste products, organic and inorganic, in solution. This destabilization allows the particulates to coagulate and form a mass, or floc, which can be removed as floating waste or sediment waste.

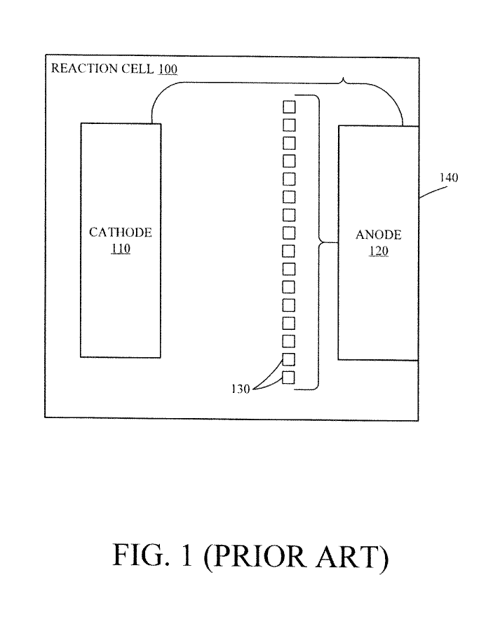

FIG. 1 illustrates a prior art waste treatment reaction cell. Reaction cell 100 comprises two electrodes, a cathode 110 coupled to an anode 120. When a charge is applied across the electrodes, sacrificial ions 130 are produced from anode 120. Additionally, anode 120 can provide at least a portion of a barrier 140 surrounding reactor cell 100. Therefore, as anode 120 produces sacrificial ions 130, it results in leaks forming within barrier 140. As illustrated in FIG. 1, a diameter of anode 120 is significantly smaller than a corresponding diameter of cathode 110, indicating that anode 120 has been in use for some time. Therefore, as anode 120 is used, it will shrink in size over time as it produces sacrificial ions, such that it eventually needs to be replaced. Additionally, replacement of anode 120 in the system may be labor intensive. Replacement may also require interruption of the electrocoagulation process.

Therefore, an electrocoagulation system that receives metal ions from an external source, separate from an anode, is desired. For example, having an electrocoagulation system receive metal ions from an external source allows for an electrocoagulation reaction to proceed without generating metal ions at an anode-cathode coupling, and degrading the anode. Such an arrangement ensures that the anode in the anode-cathode coupling does not need to be replaced periodically. Additionally, this could allow for a reduced current at the anode-cathode coupling such that only hydroxide ions and hydrogen gas are generated. At least some of the embodiments described herein provide such a system.

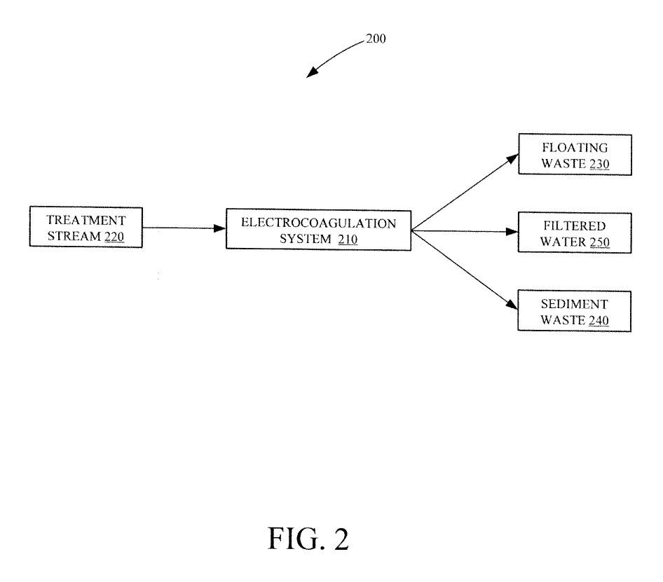

FIG. 2 illustrates a waste water treatment system in accordance with one embodiment of the present invention. In one embodiment, water treatment system 200 comprises an electrocoagulation system 210 configured to receive a water treatment stream 220 comprising at least some water with suspended contaminants. Electrocoagulation system 210, in one embodiment, is configured to conduct an electrocoagulation reaction and deliver filtered water 250 as an output. In one embodiment, the electrocoagulation reaction is conducted using metal ions supplied from an external ion source, such that an anode-cathode coupling within electrocoagulation system 210 does not produce metal ions through anode degradation alone. In one embodiment, the electrocoagulation reaction produces floc from the suspended contaminants within water treatment stream 220. In one embodiment, the floc flows to the top of electrocoagulation system 210 and is removed as floating waste 230. However, in one embodiment, the floc falls to the bottom of electrocoagulation system 210 and is removed as sediment waste 240. In other embodiments, it is understood that a mixture of floating waste 230 and sediment waste 240 is generated based on the density of the floc.

In one embodiment, as the electrocoagulation reaction progresses within electrocoagulation system 210, a cathode-anode pair within electrocoagulation system 210 electrolyzes water within treatment stream 220, producing hydroxide ions and hydrogen gas. In one embodiment, the production of hydrogen gas increases available surface area for the electrocoagulation process, and facilitates the production of floc. In one embodiment, while the cathode-anode pair produces hydroxide ions and hydrogen gas within electrocoagulation system 210, a separate ion source provides metal ions to electrocoagulation system 210. In one embodiment, this allows for an accumulation of floc within electrocoagulation system 210 without first needing to generate metal ions at a cathode-anode coupling within electrocoagulation system 210.

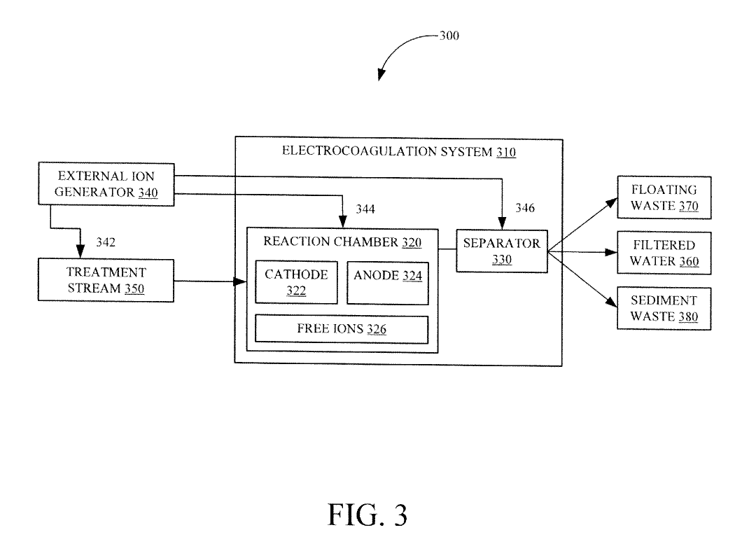

FIG. 3 illustrates a water treatment system in accordance with one embodiment of the present invention. Water treatment system 300, in one embodiment, comprises an electrocoagulation system 310. In one embodiment, electrocoagulation system 310 is configured to receive a treatment stream 350 and produce filtered water 360. In one embodiment, treatment stream 350 comprises waste water with unwanted contaminants. Based on the contaminants within treatment stream 350, after engaging an electrocoagulation reaction within a reaction chamber 320, floc is produced from the contaminants and is ejected as either floating waste 370 or sediment waste 380, based on density, for example. However, in other embodiments, a separator 330 is used in conjunction with reaction chamber 320, such that floating waste 370 or sediment waste 380 is removed in a separation operation. In one embodiment, this allows for an automatic removal of floating waste 370 or sediment waste 380 within electrocoagulation system 310.

Electrocoagulation system 310 comprises, in one embodiment, reaction chamber 320 and separator 330. However, in one embodiment, reaction chamber 320 and separator 330 are combined into a single batch chamber configured to conduct both an electrocoagulation reaction and a separation operation.

In one embodiment, reaction chamber 320 comprises a cathode 322 coupled to an anode 324. In one embodiment, reaction chamber 320 also comprises free metal ions 326 provided from an external ion generator 340.

In one embodiment, external ion generator 340 allows for anode 324 to produce fewer, or no metal ions as a reaction proceeds. In one embodiment, this allows for a continuous reaction to take place without having to periodically replace anode 324. It may also reduce leaks forming from a dissolved anode.

In one embodiment, external ion generator 340 allows for a decoupling of the metal ion generation from the electrochemistry at the anode-cathode coupling. In traditional electrocoagulation systems, a current is required to generate an adequate amount of metal ions for the electrocoagulation process, which often far exceeds a current necessary to generate adequate levels of hydrogen gas and hydroxide ions. Therefore, in one embodiment, the use of an external ion generator 340 reduces the amount of current that must be applied to reaction chamber 320. In one embodiment, the reduced current saves energy while reducing anode degradation.

In one embodiment, external ion generator 340 provides a source of free metal ions 326 directly to reaction chamber 320, as indicated by arrow 344. In one embodiment, external ion generator 340 provides a source of free metal ions 326, in solution, to separator 330, as indicated by arrow 346. In one embodiment, external ion generator 340 provides a source of free metal ions to a treatment stream 350, as indicated by arrow 342. In one embodiment, a source of free metal ions is provided to a combination of treatment stream 350, reaction chamber 344, and/or separator 330. In one embodiment, a source of free metal ions is indirectly provided to treatment stream 350, reaction chamber 344, and/or separator 330. In one embodiment, one or more porous and/or perforated electrodes are used within reaction chamber 320, in order to encourage infusion of externally generated metal ions 326 through anode 324 and/or cathode 322.

In one embodiment, external ion generator 340 comprises a sacrificial anode, separate from anode 324. In one embodiment, a sacrificial anode may allow current passing through reaction chamber 320 to generate adequate levels of hydrogen gas and hydroxide ions, while providing a balance of free metal ions necessary for electrocoagulation. In one embodiment, the use of a sacrificial anode greatly increases the lifetime of anode 324, as the anode erosion rate is directly related to the current passed through the anode-cathode coupling, and anode 324 in the anode-cathode pair, exposed to a lower amount of current, will have an operational life that is longer than conventional cathode-anode arrangements.

In one embodiment, the sacrificial anode comprises iron. In one embodiment, the sacrificial anode comprises aluminum. In one embodiment, the sacrificial anode comprises titanium. However, the sacrificial anode may also comprise any metal that, when ionized, triggers an agglomeration of impurities within reaction chamber 320.

In one embodiment, use of external ion generator 340 allows for anode 324 to become a passive anode within reaction chamber 320. External ion generator 304, in one embodiment, provides metal ions to reaction chamber 320 while a reduced current is applied to anode 324 and cathode 322. In one embodiment, the reduced current allows for a production of hydrogen gas and hydroxide ions, while allowing anode 324 to become a passive anode. In one embodiment, using a passive anode eliminates the need to periodically replace anode 324. In one embodiment, use of a passive anode extends an operational lifetime of anode 324.

External ion generator 340 may comprise any one of a variety of metal ion generators. For example, external ion generator 340 may generate metal ions 326 from bulk or scrap metal sources. In one embodiment, external ion generator 340 is an electrochemical reactor. In one embodiment, external ion generator 340 is a chemical reactor (i.e., acid baths, oxidizing agents, etc.). In one embodiment, external ion generator 340 is an external tank with a dissolved salt solution. However, in other embodiments, external ion generator 340 may comprise any other source capable of providing or generating metal ions to a treatment stream 350, or electrocoagulation system 310.

One advantage of producing metal ions 326 in an external ion generator 340, for example, is that external ion generator 340 can be configured to use highly reactive metals, for example calcium, strontium, or lithium. However, in one embodiment, external ion generator 340 uses mechanically inferior metals, such as zinc, gallium, or mercury. Additionally, in one embodiment, generating metal ions 326 externally, for example using external ion generator 340, allows for the introduction of two or more coagulation chemistries, metal ion and/or another coagulation mechanism, simultaneously, sequentially, or both.

Cathode 322 and anode 324, in one embodiment, comprise any appropriate anode/cathode combination, for example parallel plates, concentric non-parallel plates, concentric cones or pyramids, or other appropriate configurations.

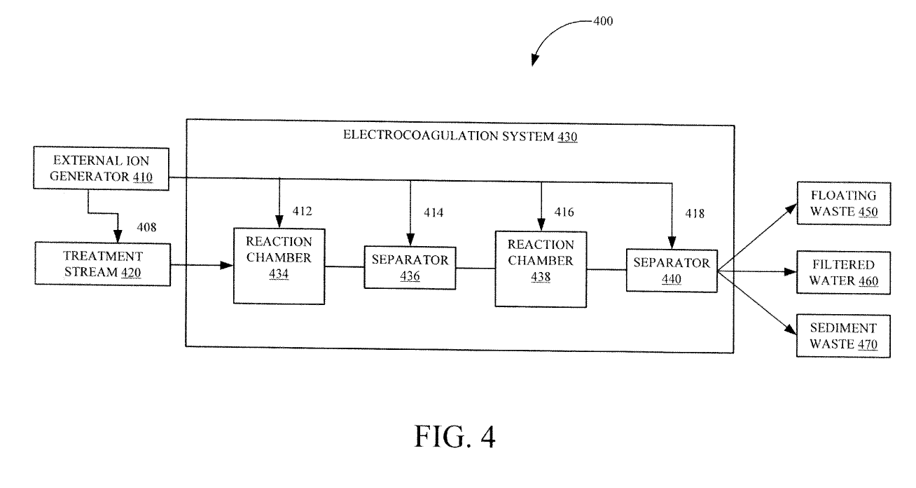

FIG. 4 illustrates a water treatment system with multiple chambers in accordance with an embodiment of the present invention. In one embodiment, water treatment system 400 comprises an electrocoagulation system 430 with multiple reaction chambers and separators. In one embodiment, electrocoagulation system 430 comprises a plurality of reaction chambers. In one embodiment, electrocoagulation system 430 comprises both reaction chambers and separators, coupled in series. However, it is to be understood that any number of reaction chambers and separators may be used, in a variety of available configurations, in accordance with other embodiments.

In one embodiment, electrocoagulation system 430 comprises multiple reaction chambers 434, 438 with multiple separators 436, 440. In one embodiment, multiple reaction chambers 434, 438 are placed in series with one or more separators 436, 440. In one embodiment, electrocoagulation system 430 is configured, as illustrated in FIG. 4, with reactors 434, 438 alternating between separators 436, 440. However, it is to be understood that any combination of reaction chambers and separators may be used in accordance with other embodiments.

In one embodiment, water treatment system 400 is configured to receive a treatment stream 420 and produce filtered water 460. In one embodiment, treatment stream 420 comprises waste water with unwanted contaminants. Based on the contaminants within treatment stream 420, floc may be produced after an electrocoagulation reaction is conducted within a reaction chamber of electrocoagulation system 430, e.g. reaction chambers 434 and/or 438. In one embodiment, the floc may be ejected as either floating waste 450 or sediment waste 470, based on density of the floc, for example, from either/both of separators 436, 440.

In one embodiment, reaction chambers 434, 438 are configured to conduct an electrocoagulation reaction. In one embodiment, each of reaction chambers 434, 438 include a cathode, an anode, and free metal ions. In one embodiment, only one reaction chamber is configured to carry out an electrocoagulation reaction. In one embodiment, this allows for a multiple reaction chamber system wherein other reactions are used in conjunction with an electrocoagulation reaction. In another embodiment, multiple reactors conduct an electrocoagulation reaction.

In one embodiment, an external ion generator 410 provides a source of free metal ions to reaction chambers 434, 438. In one embodiment, a source of free metal ions is provided to electrocoagulation system 430 in treatment stream 420, as indicated by arrow 408. In one embodiment, a source of free metal ions is provided to reaction chamber 434, as indicated by arrow 412. In one embodiment, a source of free metal ions is provided to reaction chamber 438, as indicated by arrow 416. In one embodiment, a source of free metal ions is provided to separator 436, as indicated by arrow 414. In one embodiment, a source of free metal ions is provided to separator 440, as indicated by arrow 418. In one embodiment, a source of free metal ions is supplied to a combination of reaction chambers and/or separators. In other embodiments, a source of free metal ions is indirectly supplied into any chamber and/or separator.

External ion generator 410 may comprise any one of a variety of free metal ion generators. In one embodiment, external ion generator 410 is an electrochemical reactor. In one embodiment, external ion generator 410 is a chemical reactor. For example, an acid bath, in one embodiment, oxidizing agents, in one embodiment, or other suitable reactors configured to generate a source of free metal ions. In one embodiment, external ion generator 410 is an external tank with a dissolved salt solution. However, in other embodiments, external ion generator 410 may comprise any other source capable of providing free metal ions to a treatment stream, reaction chamber, and/or separator.

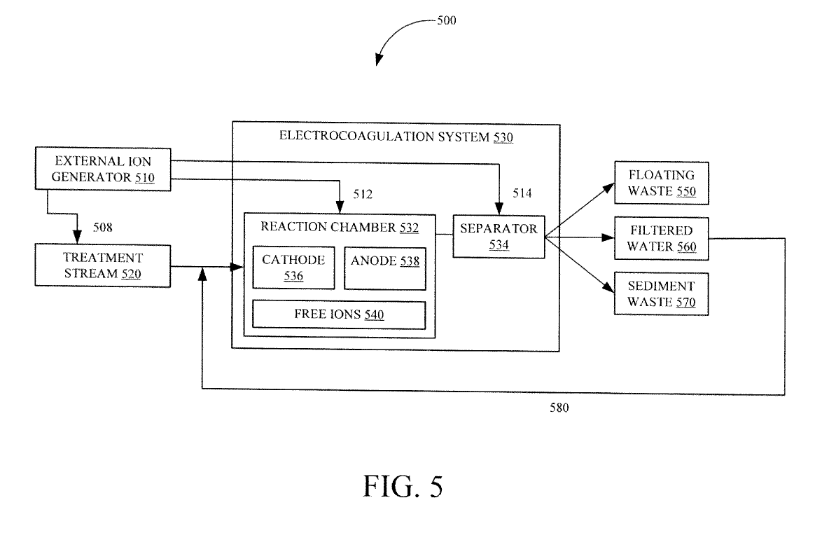

FIG. 5 illustrates a water treatment system with a recycle loop in accordance with an embodiment of the present invention. In one embodiment, a water treatment system 500 comprises an electrocoagulation system 530 that is configured to receive a treatment stream 520 and produce filtered water 560. In one embodiment, treatment stream 520 comprises waste water with a contaminant. Based on the contaminant within treatment stream 520, floc may be produced after an electrocoagulation reaction is conducted within a reaction chamber 532 of electrocoagulation system 530. In one embodiment, the floc may be ejected as either floating waste 550 or sediment waste 570, based on density of the floc, for example.

However, in one embodiment, filtered water 560 is cycled back into treatment stream 520 using a recycle loop 580. In one embodiment, this allows for a multi-pass system that allows filtered water 560 to be recycled through electrocoagulation system 530 for a second pass.

In one embodiment, water treatment facility 500 comprises electrocoagulation system 530, recycle loop 580, treatment stream 520, and an external ion generator 510. In one embodiment, recycle loop 580 comprises filtered water 550. In one embodiment, recycle loop 580 comprises filtered water 560 along with any remaining contaminates left over after a treatment process is completed. In one embodiment, recycle loop 580 is coupled to a treatment stream 520. However, in one embodiment, recycle loop 580 is coupled to electrocoagulation system 530.

In one embodiment, electrocoagulation system 530 includes reaction chamber 532 and a separator 534. In one embodiment, reaction chamber 532 is configured to conduct an electrocoagulation reaction. In one embodiment, separator 534 is configured to separate out any floating waste 540 and/or sediment waste 560 generated by reaction chamber 532. However, in one embodiment, electrocoagulation system 530 only comprises reaction chamber 532, such that any resulting waste from an electrocoagulation reaction is removed from reaction chamber 532. In one embodiment, reaction chamber 532 includes any or all of a cathode, an anode, and free metal ions.

In one embodiment, external ion generator 510 generates a source of free metal ions. In one embodiment, a source of free metal ions is provided to treatment stream 520, as indicated by arrow 508. In one embodiment, a source of free metal ions is provided to reaction chamber 532, as indicated by arrow 512. In one embodiment, a source of free metal ions is provided to separator 534, as indicated by arrow 514. In one embodiment, a source of free metal ions is provided to a combination of treatment stream 520, reaction chamber 532, and/or separator 534. In one embodiment, a source of free metal ions is provided indirectly to any of treatment stream 520, reaction chamber 532, and/or separator 534.

External ion generator 510 may comprise any one of a variety of metal ion generators. In one embodiment, external ion generator 510 is an electrochemical reactor. In one embodiment, external ion generator 510 is a chemical reactor (i.e., acid baths, oxidizing agents, etc.). In one embodiment, external ion generator 510 is an external tank with a dissolved salt solution. However, in other embodiments, external ion generator 510 may comprise any other source capable of providing preexisting metal ions to treatment stream 520, reaction chamber 532, and/or separator 534.

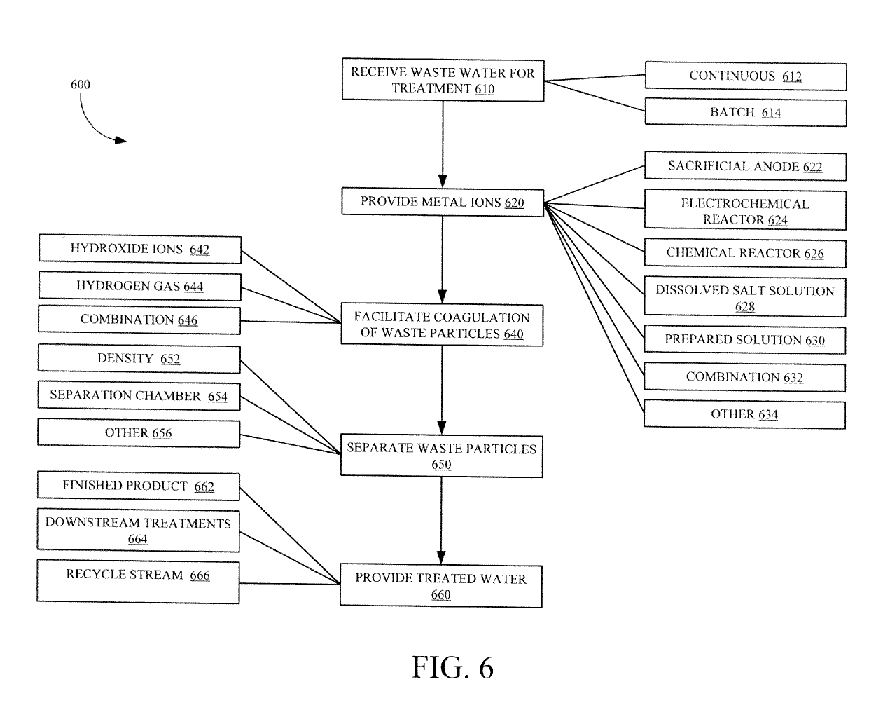

FIG. 6 illustrates one example method of treating waste water in accordance with one embodiment of the present invention. Method 600 may be utilized for either a single or multi-pass waste water treatment system, for example, any of the systems described in FIGS. 2-5, or another suitable system.

In block 610, waste water is received. This may comprise, in one embodiment, a continuous waste stream flow through a waste water system, as indicated in block 612. In another embodiment, a batch of waste water is received for treatment comprising a contaminant, as indicated in block 614.

In block 620, a source of free metal ions is provided to a water treatment system. In one embodiment, the source of free metal ions is provided to the water treatment system to carry out an electrocoagulation reaction. In one embodiment, the source of free metal ions is provided, in one embodiment, by a sacrificial anode, as indicated in block 622. In one embodiment, the source of free metal ions is provided by an electrochemical reactor, as indicated in block 624. In one embodiment, a chemical reactor provides the source of free metal ions, as indicated in block 626. In one embodiment, a dissolved salt solution provides the source of free metal ions, as indicated in block 628. In one embodiment, an already prepared solution, of the source of free metal ions, is provided, as indicated in block 630. In one embodiment, a combination of different sources may be used to provide the source of free metal ions, as indicated in block 632. However, in other embodiments, other mechanisms for providing a source of free metal ions may be used, as indicated in block 634.

In block 640, a coagulation of waste particles is facilitated. In one embodiment, the coagulation of waste particles is facilitated within a water treatment system after free metal ions are provided and are in solution with the waste water. In one embodiment, a coagulation of waste particles is facilitated by running a current across a cathode/anode coupling within the water treatment system, such that hydroxide ions are generated, as indicated in block 642. In one embodiment, a coagulation of waste particles is facilitated by running a current across a cathode/anode coupling, such that hydrogen gas is generated, as indicated in block 644. In one embodiment, a coagulation of waste particles is facilitated by running a current across a cathode/anode coupling, such that both hydroxide ions and hydrogen gas are generated, as indicated in block 646. In one embodiment, a current is run across a cathode/anode coupling such that few, or no free metal ions are generated at the cathode/anode coupling.

In block 650, produced waste particles are separated. In one embodiment, the separation occurs naturally, such that less dense floc floats to the top of the reaction chamber and denser floc floats to the bottom of a reaction chamber, as indicated in block 652. In one embodiment, this may allow for floc to be removed directly from a reaction chamber as sediment waste or floating waste. In one embodiment, the separated waste is transferred out of an electrocoagulation system using a separation chamber, as indicated in block 654. In one embodiment, this involves running the waste water through multiple filters, such that floc is removed from the system. In one embodiment, another separation mechanism is used, as indicated in block 656.

In block 660, treated water is provided. In one embodiment, treated water is provided as a finished product, as indicated in block 662. In one embodiment, treated water is provided for further downstream treatments, as indicated in block 664. However, in one embodiment, treated water is recycled back through the system for at least a second pass, as indicated in block 666.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A water treatment system comprising:
a reaction chamber comprising an anode and a cathode, the reaction chamber being configured to conduct an electrocoagulation reaction using the anode and the cathode; and
an external ion generator, separate from the anode, configured to provide a source of free metal ions to the water treatment system.

2. The water treatment system of claim 1, wherein the source of free metal ions comprise zinc ions.

3. The water treatment system of claim 1, wherein the source of free metal ions is provided to the reaction chamber.

4. The water treatment system of claim 1, wherein the reaction chamber and the water treatment system also comprises a second reaction chamber in series with the reaction chamber.

5. The water treatment system of claim 1, further comprising a separator configured to separate waste generated by the electrocoagulation reaction, wherein the source of free metal ions are provided to the separator.

6. A water treatment system comprising:
a waste water stream;
an electrocoagulation system configured to receive the waste water stream, the electrocoagulation system further comprising:
a reaction chamber configured to carry out an electrocoagulation reaction using an anode and a cathode, wherein the electrocoagulation reaction is configured to produce a floc;
a separator configured to separate out the floc; and
an external ion generator, separate from the anode, configured to provide a source of free metal ions to the electrocoagulation system; and
wherein the electrocoagulation system is configured to output a treated water stream.

7. The water treatment system of claim 6, wherein the source of free metal ions is provided to the waste water stream.

8. The water treatment system of claim 6, wherein the source of free metal ions is provided to the reaction chamber.

9. The water treatment system of claim 6, wherein the source of free metal ions is provided to the separator.

10. The water treatment system of claim 6, and further comprising a recycle stream configured to allow the treated water stream to pass through the separator at least twice.

11. The water treatment system of claim 6, wherein the source of free metal ions is configured to reduce an amount of current required to facilitate the electrocoagulation reaction.

12. The water treatment system of claim 6, wherein the reaction chamber is a first reaction chamber, and wherein the electrocoagulation system comprises a second reaction chamber coupled in series to the first reaction chamber.

13. The water treatment system of claim 12, wherein the separator is a first separator, and wherein the electrocoagulation system comprises a second separator coupled in series to the first separator.

14. A method for using an electrocoagulation reaction, comprising:
providing to a reaction chamber, a waste water source for treatment, wherein the reaction chamber comprises an anode and a cathode, and wherein the waste water source comprises a contaminant;
receiving a source of free metal ions, produced by a source other than the anode or the cathode;
running a current through the anode and the cathode, wherein the current is sufficient to trigger electrocoagulation of the contaminant into a floc; and
separating the floc from a treated fluid.

15. The method of claim 14, wherein the source of free metal ions is a sacrificial anode.

16. The method of claim 14, wherein the source of free metal ions is an electrochemical reactor.

17. The method of claim 14, wherein the source of free metal ions is a chemical reactor.

18. The method of claim 14, wherein the source of free metal ions is a dissolved salt solution.

19. The method of claim 14, wherein the waste water source is provided as a batch process.

20. The method of claim 14, and further comprising:
providing the treated fluid to the reaction chamber through a recycle loop;
running a second current through the anode and the cathode, wherein the second current is sufficient to trigger electrocoagulation of remaining contaminates in the treated fluid into a second floc; and
separating the second floc from the treated fluid.
